(19) United States
(12) Patent Application Publication
(10) Pub. No.: US 2010/0146794 A1
(43) Pub. Date: Jun. 17, 2010

(54) Vacuum trimmer

(76) Inventor: Gregory P. Marcoe, Midland, MI (US)

Correspondence Address: Timothy S. Stevens, Patent Attorney, 5108 Foxpoint Circle, Midland, MI, 48642, US

(21) Appl. No.: 12/658,831

(22) Filed: Feb. 16, 2010

Related U.S. Application Data
(62) Division of application No. 11/809,760, filed on Jun. 1, 2007.
Application No. 11/809,760 is a continuation-in-part of application No. 11/599,511, filed on Nov. 14, 2006, now abandoned.

(51) Int. Cl. A01D 34/412; A01D 34/90

(52) U.S. Cl. 30/124; 15/339; 30/276

(57) ABSTRACT

An improved hand held lawn and garden vacuum trimmer having an elongated vacuum duct in fluid communication with a motor powered vacuum impeller positioned in a body, one end of the vacuum duct being attached to the body, a rotary cutter positioned in the vacuum duct, the rotary cutter attached to the impeller by way of a rotating shaft so that material swept into the distal end of the vacuum duct is cut by the cutter, swept through the impeller and then directed to a collection container. The improvement of this embodiment of the instant invention is positioning the cutter more than one quarter inch and less than three inches from the distal end of the vacuum duct.

In addition, an improved hand held lawn and garden vacuum collector having an elongated vacuum duct in fluid communication with a motor powered vacuum impeller positioned in a body, one end of the vacuum duct being attached to the body, so that material swept into the distal end of the vacuum duct is swept through the impeller and then directed to a collection container, wherein the improvement of this embodiment of the instant invention is to position a rotary cutter and airfoil in the vacuum duct, the rotary cutter connected to the airfoil so that the rotary cutter rotates in response to air flowed through the vacuum duct.

And, a vacuum duct assembly adapted to be removeably attached to a hand held lawn and garden vacuum collector, the hand held lawn and garden vacuum collector having a motor powered vacuum impeller encased in a body. The vacuum duct assembly consists of an elongated vacuum duct having means for demountable attachment at the first end thereof to the body of the collector, a rotary cutter positioned in the vacuum duct more than one quarter inch and less than three inches from the second end of the vacuum duct, the rotary cutter attached to one end of a shaft positioned in the vacuum duct, the other end of the shaft having means for attachment to the vacuum impeller when the first end of the vacuum duct is attached to the body of the collector.

This application claims priority to and is a divisional application of U.S. patent application Ser. No. 11/809,760 filed Jun. 1, 2007. U.S. patent application Ser. No. 11/809,760 filed Jun. 1, 2007 claimed priority to and was a continuation-in-part of U.S. patent application Ser. No. 11/599,511 filed Nov. 14, 2006. The instant invention is in the field of trimmer devices suitable for lawn and garden use, and, more particularly, to trimmer devices in combination with a vacuum system for collecting the trimmer cuttings.

### BACKGROUND OF THE INVENTION

Hand held lawn care vacuum systems are known for collecting leafs and clippings by way of a vacuum duct. Such vacuum systems have been improved by positioning a cutter in the vacuum duct to chop the collected leafs and clippings and thereby increase the collection efficiency of the system as described, for example, in U.S. Pat. No. 5,586,359 and U.S. Pat. No. 5,791,568. U.S. Pat. No. 5,588,289 describes a hand held lawn care vacuum and cutting or trimming tool comprising a vacuum duct wherein the cutter is positioned at the end of the duct or at a side opening of the duct.

Hand held lawn care “string trimmers” are well known and used for trimming grass, for example, along sidewalk edges and around flower beds. Typically, the grass clippings produced by the use of a string trimmer are subsequently collected by sweeping or vacuuming. String trimmers have been improved by incorporating a vacuum system therein to both trim and collect as described, for example, in U.S. Pat. No. 5,862,595 and U.S. Pat. No. 6,751,871.

Despite the significant advances made in the art of hand held trimmers incorporating vacuum collection systems, there remains a need for a combination trimmer and vacuum system that is easier to control, safer to use and which produces a more precise, even and cleaner cut.

### SUMMARY OF THE INVENTION

The instant invention provides a combination trimmer and vacuum system that is easier to control, safer to use and which produces a more precise, even and cleaner cut. More specifically, the instant invention is an improved hand held lawn and garden vacuum trimmer comprising an elongated vacuum duct in fluid communication with a motor powered vacuum impeller positioned in a body, one end of the vacuum duct being attached to the body, a rotary cutter positioned in the vacuum duct, the rotary cutter attached to the impeller by way of a rotating shaft so that material swept into the distal end of the vacuum duct is cut by the cutter, swept through the impeller and then directed to a collection container, wherein the improvement comprises, the cutter positioned more than one quarter inch and less than three inches (preferably more than one half inch and less than two inches) from the distal end of the vacuum duct.

In another embodiment, the instant invention is an improved hand held lawn and garden vacuum collector comprising an elongated vacuum duct in fluid communication with a motor powered vacuum impeller positioned in a body, one end of the vacuum duct being attached to the body, so that material swept into the distal end of the vacuum duct is swept through the impeller and then directed to a collection container, wherein the improvement comprises, a rotary cutter and airfoil positioned in the vacuum duct, the rotary cutter connected to the airfoil so that the rotary cutter rotates in response to air flowed through the vacuum duct.

In yet another embodiment, the instant invention is a vacuum duct assembly adapted to be removeably attached to a hand held lawn and garden vacuum collector, the hand held lawn and garden vacuum collector comprising a motor powered vacuum impeller encased in a body, the vacuum duct assembly comprising: an elongated vacuum duct having means for demountable attachment at the first end thereof to the body of the collector, a rotary cutter positioned in the vacuum duct more than one quarter inch and less than three inches from the distal end of the vacuum duct, the rotary cutter attached to one end of a shaft positioned in the vacuum duct, the other end of the shaft having means for attachment to the vacuum impeller when the first end of the vacuum duct is attached to the body of the collector, so that when the vacuum duct assembly is attached to the vacuum collector, material swept into the distal end of the vacuum duct is cut by the cutter, swept through the impeller and then directed to a collection container.

### BRIEF DESCRIPTION OF THE DRAWINGS

FIG. 1 is a side view, part in cross-section and part in full of an embodiment of the instant invention having a rotary cutter positioned near the distal end of the vacuum duct thereof;

FIG. 2 is an end view of the distal end of the vacuum duct of the embodiment shown in FIG. 1:

FIG. 3 is a side view, part in cross-section and part in full of another embodiment of the instant invention having a passively powered cutter positioned near the distal end of the vacuum duct thereof;

FIG. 4 is an end view of the distal end of the vacuum duct of the embodiment shown in FIG. 3;

FIG. 5 is a side view, part in cross-section and part in full of yet another embodiment of the instant invention wherein the vacuum duct thereof comprises a detachable portion and wherein a passively powered rotary cutter is positioned in the detachable portion;

FIG. 6 is a side view, part in cross-section and part in full of a detachable vacuum duct portion containing a rotary cutter attached to a turbine wheel;

FIG. 7 is a side view, part in cross-section and part in full of a detachable vacuum duct portion having a slideable sleeve attached at the end thereof;

FIG. 8 is a side view, part in cross-section and part in full of another embodiment of the instant invention having a demountable vacuum duct assembly;

FIG. 9 is a side view, part in cross-section and part in full of another embodiment of the instant invention having a demountable vacuum duct assembly;

FIG. 10 is a side view, part in cross-section and part in full of a demountable vacuum duct assembly of the instant invention;

FIG. 11 is a side view, part in cross-section and part in full of another embodiment of the instant invention having a curved demountable vacuum duct assembly;

FIG. 12 is an end view of the demountable vacuum duct assembly shown in FIG. 11; and

FIG. 13 is a partial perspective view of a preferred embodiment of the instant invention.

### DETAILED DESCRIPTION

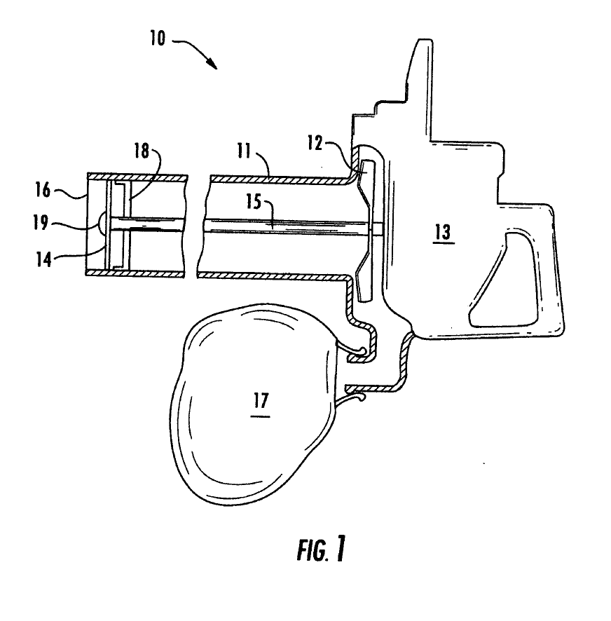

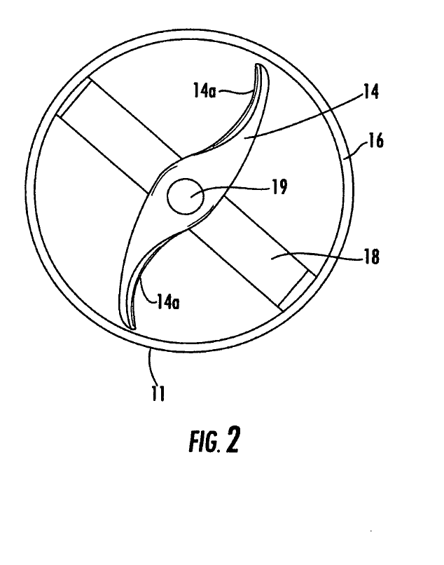

Referring now to FIG. 1, therein is shown an improved hand held lawn and garden vacuum trimmer 10 (similar in many respects to the leaf vacuum with rotary cutting blade of U.S. Pat. No. 5,586,359) which includes an elongated vacuum duct 11 in fluid communication with a motor powered impeller 12 positioned in a body 13 of the vacuum trimmer 10, one end of the vacuum duct 11 being attached to the body 13. A rotary cutter 14 is positioned in the vacuum duct 11. The rotary cutter 14 is attached to the impeller 12 by way of a rotating shaft 15 so that material swept into the distal end 16 of the vacuum duct 11 is cut by the cutter 14, swept through the impeller 12 and then directed to a collection bag 17. A support member is used to center the cutter 14 in the duct 11. A round head bolt 19 is used to fasten the cutter 14 to the shaft 15. The round head bolt 19 is preferred over a hex head bolt in the instant invention since a round head bolt is less likely to become entangled with vegetation. The motor that drives the impeller 12 of the vacuum trimmer 10 can be of any type such as an internal combustion engine or an electric motor. The improvement of the instant invention is the positioning of the cutter 14 more than one quarter inch and less than three inches from the distal end 16 of the vacuum duct 11. Referring now to FIG. 2, therein is shown an end view of the distal end of the vacuum duct of the embodiment shown in FIG. 1 wherein the cutter 14 rotates in a counterclockwise direction and wherein the cutter 14 has cutting edges 14a formed by grinding a knife edge in the cutter 14. The shape of the cutter 14 is a preferred shape in the instant invention (although a string, monofilament or cable can be used).

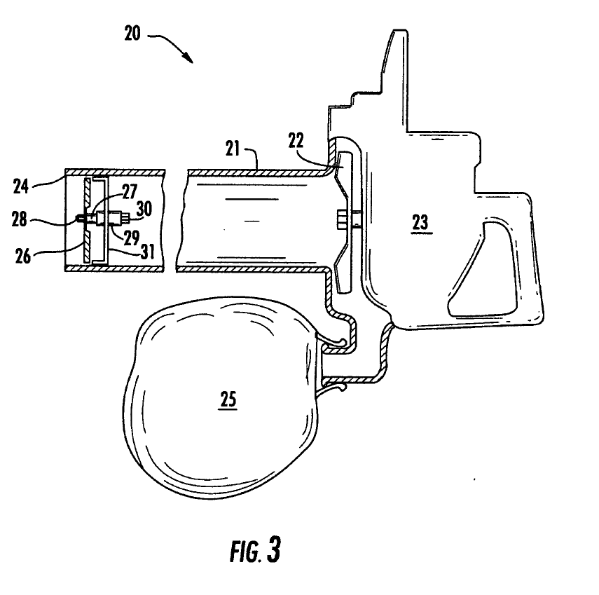

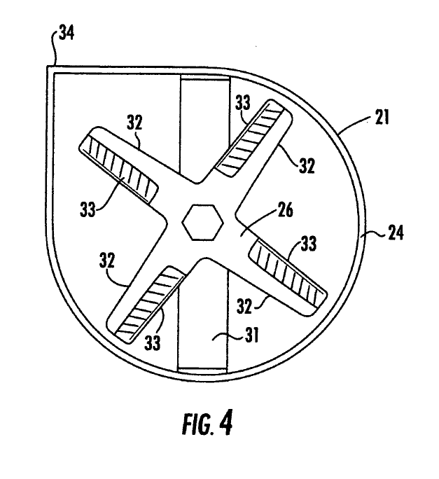

Referring now to FIG. 3, therein is shown improved hand held lawn and garden vacuum collector embodiment of the instant invention 20 comprising an elongated vacuum duct 21 in fluid communication with a motor powered impeller 22 positioned in a body 23. One end of the vacuum duct 21 is attached to the body 23, so that material swept into the distal end 24 of the vacuum duct 21 is swept through the impeller 22 and then directed to a collection bag 25. The motor that drives the impeller 22 of the vacuum trimmer 20 can be of any type such as an internal combustion engine or an electric motor. The improvement of this embodiment is a combination rotary cutter and airfoil 26 positioned in the vacuum duct 21. The combination rotary cutter and airfoil 26 is attached to one end of a pinion 27 by a bolt 28. The other end of the pinion 27 rides in bearing 29 and is retained therein by bolt 30. A bearing support member 31 supports the bearing 29 in the center of the duct 21. Referring now to FIG. 4, therein is shown an end view of the distal end 24 of the vacuum duct 21 of the embodiment shown in FIG. 3 wherein the cutter 26 rotates in a clockwise direction and wherein the cutter 26 has cutting edges 32. The rotary cutter 26 is made of stamped sheet metal having vanes 33 stamped therein so that the rotary cutter 26 rotates clockwise in response to air flowed through the vacuum duct 21. Thus the rotary cutter 26 incorporates an integral airfoil in the form of the vanes 33. The vacuum duct 21 is shaped to have a square corner 34 to facilitate trimming of vegetation in inside corners such as in the inside corner of a wall.

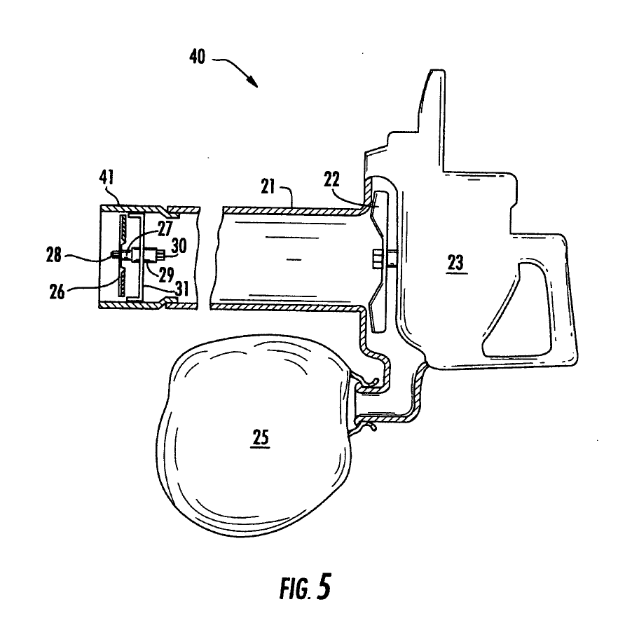

Referring now to FIG. 5, therein is shown yet another embodiment 40 of the instant invention like the embodiment shown in FIG. 3 (and wherein the same elements have the same reference numbers) wherein the vacuum duct thereof comprises a detachable portion 41 inserted into the end of the duct 21 and wherein the rotary cutter and airfoil 26 is positioned in the detachable portion 41.

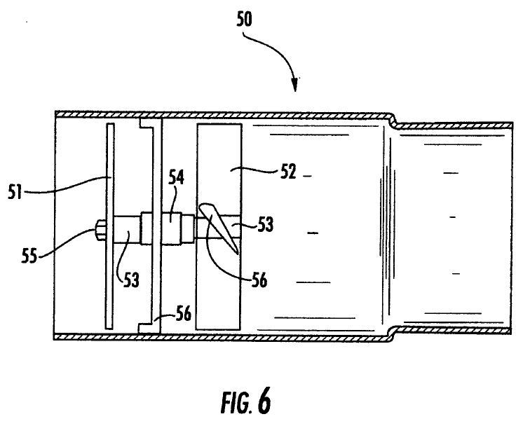

Referring now to FIG. 6, therein is shown a side view, part in cross-section and part in full of a detachable vacuum duct portion 50 containing a rotary cutter 51 (like the rotary cutter 14 of FIGS. 1 and 2) attached to a turbine wheel 52 by way of shaft 53. Shaft 53 turns in bearing 54. Bolt 55 is used to attach rotary cutter 51 to shaft 53. A bearing support member 56 supports the bearing 54 in the center of the duct portion 50. Turbine wheel 52 comprises a plurality of airfoil blades 56 designed to provide optimum cutting power to the cutter 51. Turbine wheel 52 also acts as a flywheel thereby storing rotational energy for more demanding transitory cutting tasks.

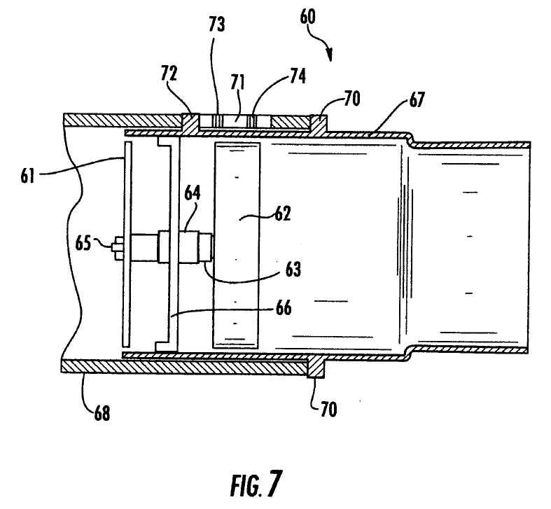

Referring now to FIG. 7, therein is shown a side view, part in cross-section and part in full of a detachable vacuum duct portion 60 (similar in some respects to the detachable vacuum duct portion 50 of FIG. 6) containing a rotary cutter 61 (like the rotary cutter 14 of FIGS. 1 and 2) attached to a turbine wheel 62 by way of shaft 63. Shaft 63 turns in bearing 64. Bolt 65 is used to attach rotary cutter 61 to shaft 63. A bearing support member 66 supports the bearing 64 in the center of the duct portion body 67. Turbine wheel 62 comprises a plurality of airfoil blades designed to provide optimum cutting power to the cutter 61. A slideable sleeve 68 is fitted to the duct portion body 67 and is shown in its fully retracted position abutting against stop ridge 70. The end of the sleeve 68 is configured in a wave pattern. The sleeve 68 can be extended until the end of the slot 71 contacts pin 72. Recesses 73 and 74 in slot 71 are dimensioned to receive the pin 72 so that the sleeve 68 can be twisted to retain sleeve 68 at the intermediate position of the recesses 73 or 74. Such a slideable sleeve can, of course, be fitted to any vacuum duct or vacuum duct portion of the instant invention.

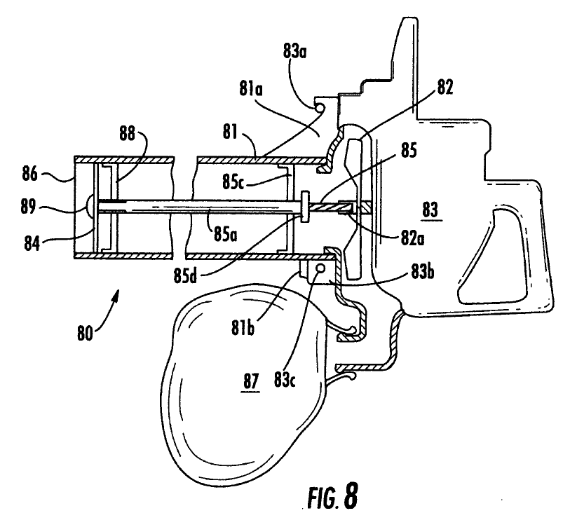

Referring now to FIG. 8, therein is shown a hand held lawn and garden vacuum trimmer 80 (similar in some respects to the leaf vacuum with rotary cutting blade of U.S. Pat. No. 5,586,359) which includes an elongated vacuum duct 81 the first end of which is demountably attached to a body 83 of the vacuum trimmer 80. The vacuum trimmer 80 comprises a motor powered impeller 82 positioned in a body 83 of the vacuum trimmer 80. A rotary cutter 84 is positioned in the vacuum duct 81. The rotary cutter 84 is attached to the impeller 82 by way of a rotating shaft 85 so that material swept into the second end 86 of the vacuum duct 81 is cut by the cutter 84, swept through the impeller 82 and then directed to a collection bag 87. Support members 88 and 85c are used to center the tube 85a in the duct 81. A round head bolt 89 is used to fasten the cutter 84 to the shaft 85. The motor that drives the impeller 82 of the vacuum trimmer 80 can be of any type such as an internal combustion engine or an electric motor. A flange 81a attached to the duct 81 engages with a stud 83a of the body 83. A tab 81b attached to the tenon 81b engages with a mortise 83b of the body 83 and is secured by pin 83c. The rotating shaft 85 is a flexible cable supported by a tube 85a. Thrust washer 85d is crimped to the shaft 85 which terminates with a squared section engaged with socket portion 82a of the impeller shaft. In use, the flange 81a of the duct assembly is engaged with the stud 83a and pivoted into full engagement with the body 83 so that the pin 83c can be inserted, taking care that the square end of the shaft 85 engages with the socket portion 82a.

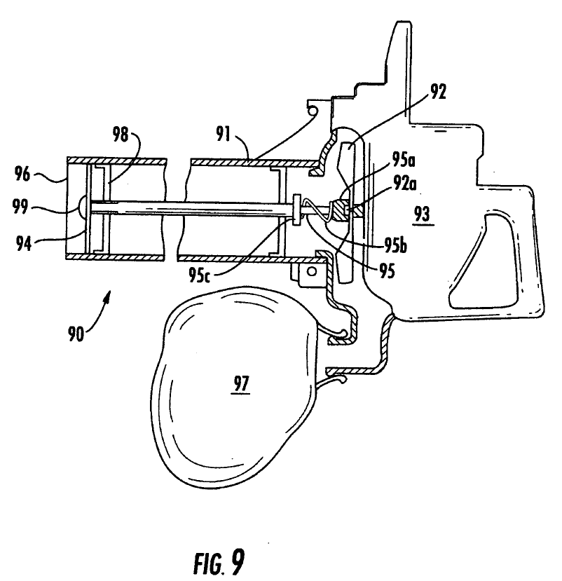

Referring now to FIG. 9, therein is shown a hand held lawn and garden vacuum trimmer 90 (similar in most respects to the trimmer shown in FIG. 8) which includes an elongated vacuum duct 91 the first end of which is demountably attached to a body 93 of the vacuum trimmer 90. The vacuum trimmer 90 comprises a motor powered impeller 92 positioned in a body 93 of the vacuum trimmer 90. A rotary cutter 94 is positioned in the vacuum duct 91. The rotary cutter 94 is attached to the impeller 92 by way of a rotating shaft 95 so that material swept into the second end 96 of the vacuum duct 91 is cut by the cutter 94, swept through the impeller 92 and then directed to a collection bag 97. A round head bolt 99 is used to fasten the cutter 94 to the shaft 95. The motor that drives the impeller 92 of the vacuum trimmer 90 can be of any type such as an internal combustion engine or an electric motor. The rotating shaft 95 is a flexible cable which terminates with a spring biased socket 95a which is shown engaged with the hex nut end 92a of the impeller shaft. The socket 95a is biased by spring 95b pressing against socket 95a and washer 95c.

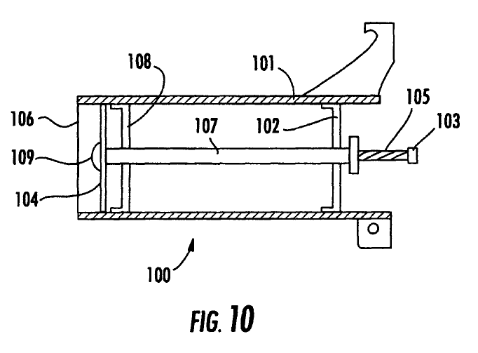

Referring now to FIG. 10, therein is shown a vacuum duct assembly 100 of the instant invention (similar in most respects to the assembly shown in FIG. 9) which includes an elongated vacuum duct 101. A rotary cutter 104 is positioned in the vacuum duct 101. The rotary cutter 104 is intended to be attached to an impeller hex nut end by way of a rotating shaft 105 so that material swept into the second end 106 of the vacuum duct 101 is cut by the cutter 104, swept through the impeller and then directed to a collection bag. A round head bolt 109 is used to fasten the cutter 104 to the shaft 105. The rotating shaft 105 is a flexible cable which terminates with a socket 103 which is to be engaged with the hex nut end of the impeller shaft. In use, the flange of the duct assembly 100 is engaged with the stud of a vacuum collector body and pivoted into full engagement with the body, taking care that the socket 103 engages with the impeller hex nut end.

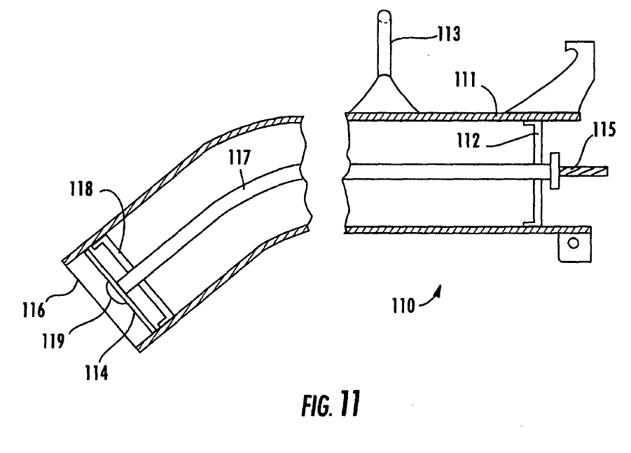

Referring now to FIG. 11, therein is shown a vacuum duct assembly 110 of the instant invention (similar in most respects to the assembly shown in FIG. 10) which includes an elongated and curved vacuum duct 111. A rotary cutter 114 is positioned in the vacuum duct 111. The rotary cutter 114 is intended to be attached to an impeller socket portion by way of a rotating shaft 115 so that material swept into the second end 116 of the vacuum duct 111 is cut by the cutter 114, swept through the impeller and then directed to a collection bag. A round head bolt 119 is used to fasten the cutter 114 to the shaft 115. The rotating shaft 115 is a flexible cable which terminates with a squared end which is to be engaged with a socket end portion of an impeller shaft. A handle 113 is attached to the duct 111. In use, the flange of the duct assembly 110 is engaged with the stud of a vacuum collector body and pivoted into full engagement with the body, taking care that the end of the shaft 115 engages with the socket portion of the impeller shaft.

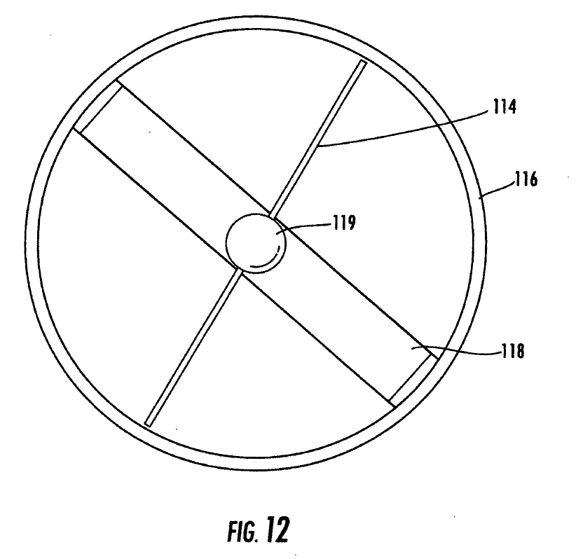

Referring now to FIG. 12, therein is shown an end view of the distal end of the vacuum duct of the embodiment shown in FIG. 11 wherein the cutter 114 is comprised of monofilament.

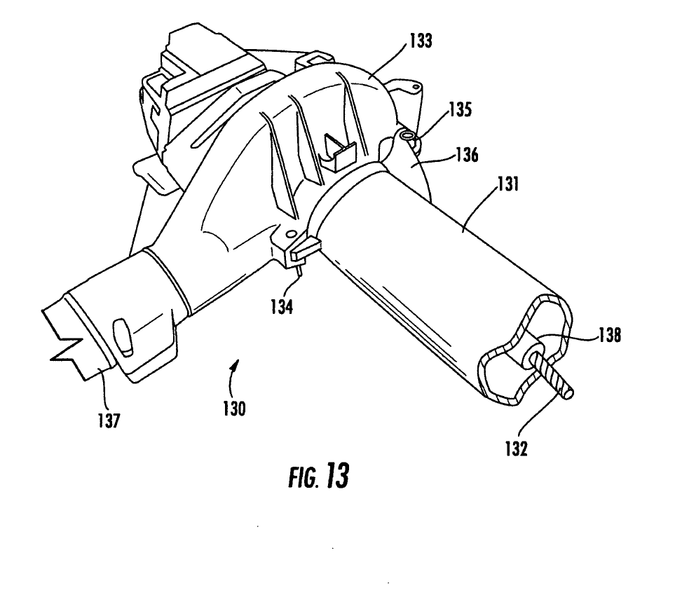

Referring now to FIG. 13, therein is shown a partial perspective view of a preferred embodiment 130 of the instant invention including an elongated vacuum duct 131 attached to the body 133 of a motor powered vacuum collector by way of a flange 136 of the duct 131 engaged with a stud 135 of the body 133 and a mortise and tenon joint secured by pin 134. A collection bag 137 is attached to the body 133 for collecting trimmings. A tube 138 is shown supporting a flexible cable 132. Such flexible cable is widely used in string trimmers, especially for curved shaft string trimmers.

It should be understood that the vacuum duct and/or vacuum duct portion of the instant invention can be curved or straight. It should be understood that the distal end of the vacuum duct or vacuum duct portion of the instant invention can be straight, wavy, saw-toothed or otherwise configured and such configurations can be preferred as a means of preventing the vacuum duct from suddenly being sucked onto a surface. When the distal end of the vacuum duct or vacuum duct portion of the instant invention is configured, then the distal end of the vacuum duct or vacuum duct portion is measured as the shortest distance from the configured distal end of the vacuum duct or vacuum duct portion.

The instant invention can be used, for example, to trim grass along the edge of a sidewalk or the like by suspending or lightly dragging the distal end of the vacuum duct along the boundary between the sidewalk and the grass. A primary benefit of the instant invention is the recessed positioning of the rotary cutter in the vacuum duct (or detachable vacuum duct portion) but near the distal end of the vacuum duct (or detachable vacuum duct portion) thereby tending to straighten and align the grass (or other vegetation) as it is trimmed thereby producing an even cut in a relatively safe and clean manner. An additional benefit of the instant invention is the limitation of the amount of vegetation trimmed depending on the recessed position of the rotary cutter in the vacuum duct (or detachable vacuum duct portion) thereby avoiding overly short trimming or “scalping”. Another benefit of the instant invention is the ready conversion of a conventional lawn and garden vacuum collector to a vacuum trimmer by the addition of a detachable vacuum duct portion containing a cutter or a cutter and airfoil according to the instant invention. A special benefit of the embodiment of the instant invention using the cutter and airfoil is the very high rotational speed that such a cutter can be driven by the airfoil, thereby driving the cutter to produce a cleaner cut.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains and which fall within the limits of the following claims.

1. An improved hand held lawn and garden vacuum trimmer comprising an elongated vacuum duct in fluid communication with a motor powered vacuum impeller positioned in a body, one end of the vacuum duct being attached to the body, a rotary cutter positioned in the vacuum duct, the rotary cutter attached to the vacuum impeller by way of a rotating shaft so that material swept into the distal end of the vacuum duct is cut by the cutter, swept through the impeller and then directed to a collection container, wherein the improvement comprises, the cutter positioned more than one quarter inch and less than three inches from the distal end of the vacuum duct.

2. The improved hand held lawn and garden vacuum trimmer of claim 1, wherein the cutter is positioned more than one half inch and less than two inches from the distal end of the vacuum duct.

3. (canceled)

4. The improved hand held lawn and garden vacuum collector of claim 3, wherein the airfoil is integral with the rotary cutter.

5. (canceled)

6. (canceled)

7. The improved hand held lawn and garden vacuum collector of claim 4, wherein the vacuum duct comprises a detachable portion at the distal end thereof, the rotary cutter and airfoil being position in the detachable portion.

8. (canceled)

9. A vacuum duct assembly adapted to be removeably attached to a hand held lawn and garden vacuum collector, the hand held lawn and garden vacuum collector comprising a motor powered vacuum impeller encased in a body, the vacuum duct assembly comprising: an elongated vacuum duct having means for demountable attachment at the first end thereof to the body of the collector, a rotary cutter positioned in the vacuum duct more than one quarter inch and less than three inches from the second end of the vacuum duct, the rotary cutter attached to one end of a shaft positioned in the vacuum duct, the other end of the shaft having means for attachment to the vacuum impeller when the first end of the vacuum duct is attached to the body of the collector, so that when the vacuum duct assembly is attached to the vacuum collector, material swept into the second end of the vacuum duct is cut by the cutter, swept through the impeller and then directed to a collection container.

10. The vacuum duct assembly of claim 9, wherein the shaft is a flexible cable.

11. The vacuum duct assembly of claim 9, wherein the cutter is positioned more than one half inch and less than two inches from the second end of the vacuum duct.

12. The vacuum duct assembly of claim 10, wherein the cutter is positioned more than one half inch and less than two inches from the second end of the vacuum duct.
